(19) United States
(12) Patent Application Publication
(10) Pub. No.: US 2020/0340650 A1
(43) Pub. Date: Oct. 29, 2020

(54) EASY HOOK

(71) Applicant: Martin DeJesus Flores, Fontana, CA (US)

(72) Inventor: Martin DeJesus Flores, Fontana, CA (US)

(21) Appl. No.: 16/396,207

(22) Filed: Apr. 26, 2019

(51) Int. Cl. F21V 21/08; A47G 33/00; F16B 45/00; F16M 13/02

(52) U.S. Cl. CPC F21V 21/08; F16M 13/02; F16B 45/00; A47G 33/00

(57) ABSTRACT

A hook for hanging decorations to a structure is presented. The hook is useful for providing an effective way to hang exterior or interior decorations, such as Christmas lights, ornaments, etc. The hook eliminates repetitive need to install and remove hardware yearly. The hook increases the convenience and safety for the user hanging decorations by providing a rigid connector that can withstand high winds, cold weather and precipitation while remaining installed year over year. The hook has a coupling for holding a decoration. The coupling is for inserting and removing the decoration. The hook has a connector coupled to the coupling on a first end and a second end of the connector being coupled to a structure. The coupling may be a hook shape. The coupling may be made of a hard plastic. The connector may be a screw. The opening of the coupling accesses a void area and a clasp is coupled to the opening of the coupling to further secure the void area of the coupling.

### FIELD OF THE INVENTION

This invention relates to hooks. More particularly, it relates to hooks for hanging decorations on or in a house.

### BACKGROUND

Christmas lights (also known as fairy lights) are lights used for decoration in celebration of Christmas, often on display throughout the season including Advent and Christmastide. The custom goes back to when Christmas trees were decorated with candles, which symbolized Christ being the light of the world; these were brought by Christians into their homes in early modern Germany.

Christmas trees displayed publicly and illuminated with electric lights became popular in the early 20th century. By the mid-20th century, it became customary to display strings of electric lights along streets and on buildings; Christmas decorations detached from the Christmas tree itself. In the United States, it became popular to outline private homes with such Christmas lights in tract housing beginning in the 1960s. By the late 20th century, the custom had also been adopted in other nations, including outside the Western world, notably in Japan and Hong Kong. Throughout Christendom, Christmas lights continue to retain their symbolism of Jesus as the light of the world.

In many countries, Christmas lights, as well as other Christmas decorations, are traditionally erected on or around the first day of Advent. In the Western Christian world, the two traditional days when Christmas lights are removed are Twelfth Night and Candlemas, the latter of which ends the Christmas-Epiphany season in some denominations. Leaving the decorations up beyond Candlemas is historically considered to be inauspicious.

From the 1960s, beginning with tract housing in the U.S., it became increasingly common to completely outline the house (but particularly the eaves) with weatherproof Christmas lights or the interior of a building.

A familiar pastime during the holiday season is to drive or walk around neighborhoods in the evening to see the lights displayed on and around other homes. While some homes have no lights, others may have incredibly ornate displays which require weeks to construct.

Many people struggle while putting Christmas lights on their eaves or hanging decorations in their house. They use staples and nails while putting up the decorations. It is a time consuming and tedious job as well as dangerous using a hammer, stapler, staple-gun, etc. while standing on a ladder. Therefore, there is a need to provide an effective was to hang exterior or interior Christmas lights, ornaments, decorations, etc.

### BRIEF DESCRIPTION OF THE DRAWINGS

FIG. 1 is an illustrated view of a hook to hang decorations.

FIG. 2 is an illustrated use the hook shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

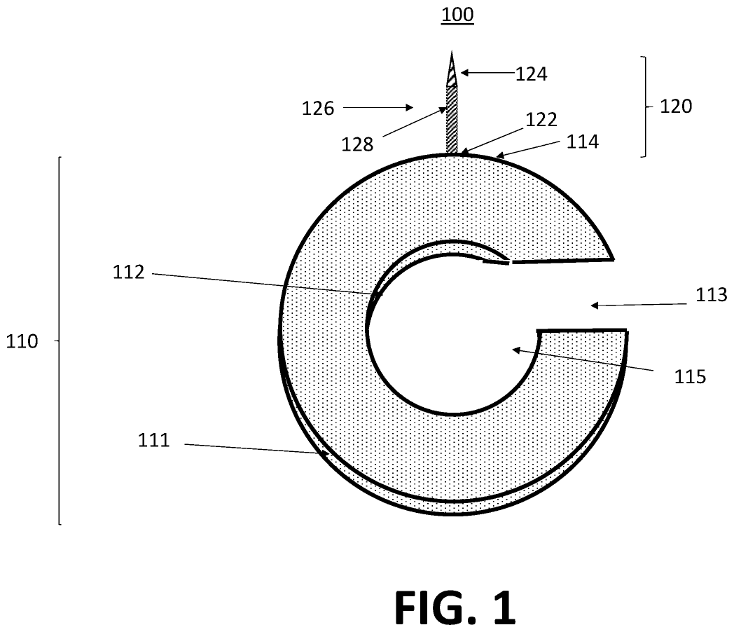

Referring to FIG. 1, a hook 100 for hanging decorations is presented. The hook 100 is useful for providing an effective way to hang exterior or interior decorations, such as Christmas lights, ornaments, etc. The hook 100 eliminates repetitive need to install and remove hardware yearly. The hook 100 increases the convenience and safety for the user hanging decorations by providing a rigid connector that can withstand high winds, cold weather and precipitation while remaining installed year over year.

The hook 100 has a coupling 110 and a connector 120. The coupling 110 is preferably a round shape, but may be oblong, rectangular, trapezoidal, square, etc. The coupling 110 is preferably made of a hard-plastic material but may be made of aluminum, steel, high-density polyethylene, etc.

The coupling 110 has an outside 111, an inside 112, an opening 113, a top 114 and a void area 115. The void area 115 of the coupling 110 between the outside 111 of the coupling 110 and the inside 112 of the coupling 110.

The void area 115 of the coupling 110 is preferably one (1) inch, but may be any area that may sufficiently provide support for hanging wires, cords, decorations, etc. The opening 113 of the coupling 110 is useful for allowing access to the void area 115 of the coupling 110 to hold the decorations or other items which are desired to be securely hung. The opening 113 of the coupling 110 is preferably an open area, but may be a clip, tension rod, clasp, etc. to securely open and close entry to the void area 115 of the coupling 110. The void area 115 preferably has a diameter of seven (7) millimeters, but other diameters are hereby contemplated including, but not limited to, five (5) millimeters, eight (8) millimeters, etc. The opening 113 preferably has a width of six (6) millimeters, but other widths are hereby contemplated including, but not limited to, three (3) millimeters, seven (7) millimeters, etc.

The connector 120 is preferably a screw, but may be a bolt, Velcro, two-sided tape, etc. The connector 120 has a first end 122, a second end 124 and a body 126. The first end 122 is preferably flat, but may be concave out, a Philips-like shape, an Allen-wrench type shape, etc. The connector 120 is preferably steel, but may be other materials such as aluminum, titanium, hard plastic, etc.

The connector 120 and the coupling 110 are preferably a single piece being made of the same material, but it is hereby contemplated that the connector 120 and the coupling 110 are two separate pieces and may be made of different materials. The connector 120 and the coupling 110 are generally made of a single mold using the same material.

The connector 120 is securely coupled to the coupling 110 at substantially the top 114 of the outside 111 of the coupling 110. The coupling 110, in FIG. 1, has the connector 120 securely coupled between the outside 111 of the coupling and the inside 112 of the coupling 110.

The body 126 of the connector 120 is preferably cylindrical in shape, but may be other shapes such as round, rectangular, oblong, etc. The connector 120 is preferably configured to be coupled to wood, but may be configured to be coupled to aluminum, vinyl, steel, etc. The body 126 has a thread 128. The thread 128 is preferably a fine thread, but may be any type of thread that may be useful for staying securely coupled to a house.

The second end 124 is preferably a pointed end, but may be flat, flat screw-driver shaped, etc. The second end 124 may be useful in boring into a surface to secure the coupling while in use and while idle. The second end 124 is preferably coupled to a soffit of a house, but may be coupled to other structures such as cabinets, gutters, eaves, roofs, interior walls, moldings, etc.

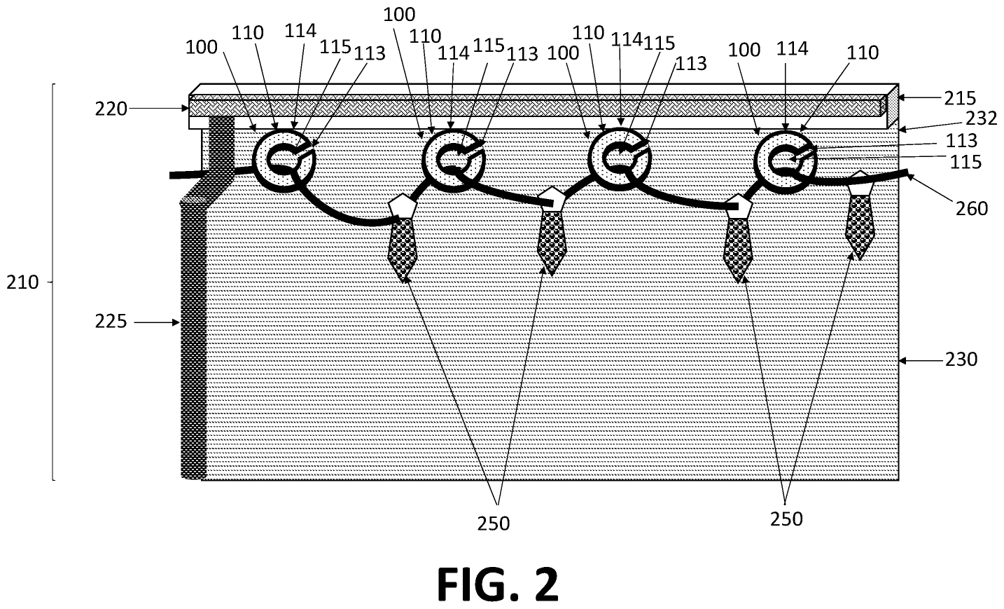

Moving now to FIG. 2, an illustrative use of the hook 100 as shown in FIG. 1 is presented.

A side of the house 210 is shown wherein the hook 100 is being used. The house 210 has a soffit 215, a gutter 220, a down spout 225 and a wall 230. The house 210 is being used in a decorative fashion showing decorations 250.

The wall 230 protects inside of the house 210 and further helps to keep wind out, and elements and strangers from entering. The wall 230 of the house 210 has a top side 232 which is coupled to the soffit 215 of the house 210.

The gutter 215 is useful for helping to carry rain or snow away from the house 210 to prevent damaging the house 215. The gutter 215 is securely coupled to the soffit 215 of the house 210 substantially close to a roof (not shown).

The gutter 220 is coupled to the downspout 225. The downspout 225 of the house 210 is useful for receiving the rain or snow received by the gutter 220 and transferring it in a downward direction to the ground. Some downspouts are configured to carry the rain to a location significantly away from the house, some downspouts release the rain to a spreader plate, etc.

The hooks 100 are securely coupled to the soffit 215 of the house 210 by screwing the connector 120 into the soffit 215 of the house 210. The hook 100 is secured to the house 210 such that the hook 100 can be semi-permanent, that being that it can remain in place for an indeterminant amount of time or until the user decides to remove the hook 100 from the soffit 215 of the house 210.

A string of lights 260 is threaded through the opening 113 of the coupling 110. The string of lights 260 are thereby threaded through the coupling 110 and are supported in the void area 115 of the coupling 110. The string of lights 260 may then be turned on or plugged in and each of the one or more lights 262 of the string of lights 260 are lit.

To remove the string of lights 260 from the hooks 100, the user unplugs or turns off the string of lights 260. The string of lights 260 is removed from each of the hooks 100 by taking the string of lights 260 from the void area 115 of the coupling 110 through the opening 113 towards the outside 111 of the coupling 110. Once the entire string of lights 260 has been removed from each of the hooks 100, the string of lights 260 can be stored. Other decorations may be placed onto the hooks 100 in a similar manner when the hooks 100 are not currently in use or when there are already items coupled to the coupling 110 of the hooks 100.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A hook for hanging decorations, the hook comprising:
a coupling, the coupling for holding a decoration;
the coupling having an opening, the opening for inserting and removing the decoration;
a connector, the connector being coupled to the coupling on a first end; and
a second end of the connector being coupled to a structure.

2. The hook of claim 1, wherein the coupling being a hook shape.

3. The hook of claim 1, wherein the coupling being made of a hard plastic.

4. The hook of claim 1, wherein the coupling being made of aluminum.

5. The hook of claim 1, wherein the connector being a screw.

6. The hook of claim 1, wherein the first end of the connector being flat.

7. The hook of claim 1, wherein the connector being made of a metal material.

8. The hook of claim 7, wherein the metal material being steel.

9. The hook of claim 7, wherein the metal material being aluminum.

10. The hook of claim 1, wherein the second end of the connector being pointed.

11. The hook of claim 1, the connector further comprising having a body, the body coupled to the first end of the connector and the body coupled to the second end of the connector.

12. The hook of claim 11, wherein the body being threaded.

13. The hook of claim 1, wherein the second end being threaded.

14. The hook of claim 1, further comprising the opening of the coupling having a void area; and
a clasp, the clasp being for further securing the void area of the coupling.

15. A hook of claim 14, wherein the clasp is closed to secure the decoration in the void area of the hook.

16. A hook of claim 14, wherein the clasp is opened to remove the decoration from the void area of the hook.

17. The hook of claim 14, wherein the void area having a diameter being seven (7) millimeters.

18. The hook of claim 1, wherein the opening being six (6) millimeters in width.

19. The hook of claim 1, wherein the coupling and the connector being made of a same mold.

20. The hook of claim 1, wherein the coupling and the connector being made of the same material.
